(19) United States
(12) Patent Application Publication
(10) Pub. No.: US 2008/0085765 A1
(43) Pub. Date: Apr. 10, 2008

(54) ELECTRONIC GAME TRACKING ADAPTER

(76) Inventor: Sung PARK, Newton, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/856,306

(22) Filed: Sep. 17, 2007

Related U.S. Application Data
(60) Provisional application No. 60/825,870, filed on Sep. 15, 2006.

(51) Int. Cl. G06F 17/00

(52) U.S. Cl. 463/29

(57) ABSTRACT

An electronic game tracking adapter facilitates deployment, use, and sponsoring of electronic games in a manner that avoids limitations associated with proprietary solutions. The electronic game tracking adapter provides a basis for rewarding game developers, sponsors, and the like. The adapter further provides methods and systems for game assessment, feedback, market research, trial offers, subscription, pay-per-use and the like. An electronic game tracking adapter facilitates local and on-line gaming, including multi-player games, online interactive games, sample games, downloaded games, uploading games, and the like. Access to games, features of games, and repeated use of a game may be enabled by the methods and systems provided by the electronic game tracking adapter. The electronic game tracking adapter facilitates aspects of social networking, such as determining membership in online clubs, access to individuals' online information associated with a social networking site or page, and distribution and tracking of games offered through social networking sites.

### CROSS-REFERENCE TO RELATED APPLICATIONS

This application claims the benefit of the following provisional application that is hereby incorporated by reference in its entirety:

U.S. Provisional App. No. 60/825,870 filed Sep. 15, 2006.

### BACKGROUND

1. Field

This invention generally relates to electronic gaming and particularly relates to tracking use of electronic games and other digital media.

2. Description of the Related Art

Handheld electronic game platforms frequently use proprietary platforms that limit the available community of sponsors and in turn limit the number of available games and related media. Due to the proprietary nature of game platforms, many game developers do not have access to the platforms without working out costly and complex business arrangements with the providers of the proprietary electronic game platforms. Game developers and users have found electronic games to by an excellent source of entertainment and skill develop that should be available without the constraints described above. Game developers and users may also desire access to free or low cost games that provide a level of visualization and challenge similar to the proprietary games. Therefore, a need exists for methods and systems that allow the development of games and related media by a wider community of sponsors, while supporting measured distribution and/or use of the games to allow for methods and systems that reward content providers for usage of the games.

### SUMMARY

An electronic game tracking platform may facilitate deployment, use, and sponsoring of electronic games in a manner that avoids limitations associated with proprietary solutions. The electronic game tracking platform may provide a basis for rewarding game developers, sponsors, and the like. The platform may further provide methods and systems for game assessment, feedback, market research, trial offers, subscription, pay-per-use and the like. An electronic game tracking platform may be embodied as a game console, handheld game, handheld game controller, a USB dongle, electronic components within a standard computing facility, software deployed on a gaming device or computer, and the like.

An electronic game tracking platform may facilitate tracking aspects of a game, such as a count of executions that may include the number of times the game is played, the duration of time a game is played, a count of game events (such as number of laps completed, levels completed, opponents defeated, items captured, property accumulated, goals achieved, items acquired, challenges overcome, lives lost, levels failed, times defeated, items lost, property lost, goals not achieved, and a wide range of other game events), processor time used, or the like. An electronic game tracking platform may facilitate local and on-line gaming, including multi-player games, online interactive games, sample games, downloaded games, uploading games, and the like. Access to games, features of games, and repeated use of a game may be enabled by the methods and systems provided by the electronic game tracking platform.

The electronic game tracking platform may facilitate aspects of social networking, such as determining membership in online clubs, access to individuals' online information associated with a social networking site or page, distribution and tracking of games offered through social networking sites, and the like.

In an aspect of the invention, a method includes providing an external and removable memory device, wherein the memory device is adapted to track a host computing facility accessing a code that is stored in the memory device.

In the method, the memory device is a USB memory device. The code is stored, from time to time, into a memory device by host computing facility. The code is part of a computer program that is stored, from time to time, into the memory device by a host computing facility.

In the method, the computer program is a computer game.

In the method, the memory device is further adapted to provide a report signal to a host computing facility, wherein the report signal encompasses information relating to the tracking. The report signal appears as a file in a file system of the memory device.

In the method, the host facility stores the game program without the use of digital rights management. The game program is associated with an open-source software development kit.

In another aspect of the invention, a method includes receiving information from a USB memory device, wherein the information is associated with an execution by a host computing facility of a program that is stored in the memory device.

In the method, the information is generated by the memory device itself. The information includes at least two of a game execution, game time, and a game event. Game time includes one or more of an accumulation of time the game is played, duration of a game execution, and a percent of idle time during a game execution. A game event is selected from the group consisting of downloading a game, uploading a game, starting a game, ending a game, pausing a game, defeating an opponent, capturing a game item, accumulating a game property, attempting a game level, completing a game level, achieving a goal, overcoming a challenge, loosing a game life, defeat, losing items, losing acquired property, reaching a game start count threshold, accessing a game feature, and adding a game participant to a game execution session.

In another aspect of the invention, a system includes an external and removable memory device for tracking access to a code that is stored in the memory device. The memory device is a USB memory device.

The system further includes a host for storing the code, from time to time, into the memory device. In the system, the code is part of a computer program, and wherein the host stores the computer program, from time to time, into the memory device. The computer program is a computer game. The game program is stored without the use of digital rights management. The game program is associated with an open-source software development kit.

In the system, the memory device is further adapted to provide a report signal to a host computing facility, wherein the report signal encompasses information relating to the tracking.

The system further includes a file system in the memory device for storing a file including the report signal. The information includes at least two of a game execution, game time, and a game event. In the system, game time includes one or more of an accumulation of time the game is played, duration of a game execution, and a percent of idle time during a game execution.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts an architecture of an electronic game platform.

FIG. 2 depicts an aspect of the game platform that is removable.

FIG. 3 depicts an online electronic game tracking embodiment.

FIG. 4 depicts a plurality of electronic game tracking facilities, associated tracking reports, and a relationship between the games and sponsors of the games.

### DETAILED DESCRIPTION

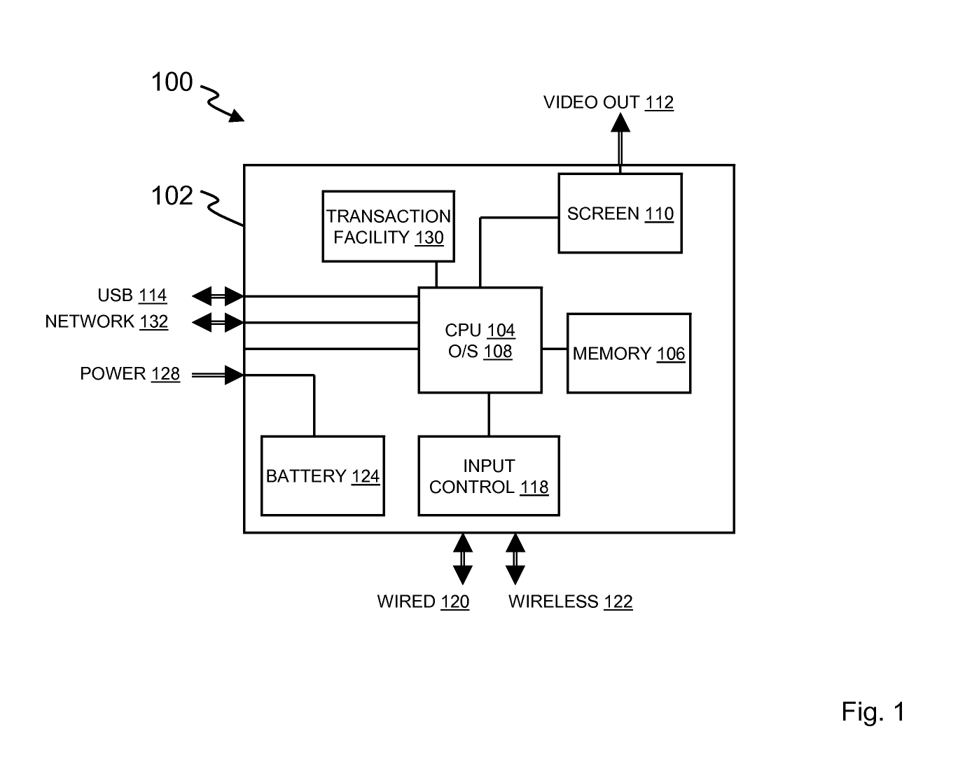

Referring to FIG. 1, aspects of an electronic game platform, including a handheld facility 102 for receiving and executing a game program, will be described. Additional aspects may include an external memory device 202 for storing and tracking game program execution, methods and systems for accessing a code associated with a game program, methods and systems for recording execution of a game program, and methods and systems for tracking execution of aspect of a game program, and for controlling execution of a game. These and other aspects provide a foundation for an electronic gaming platform that may facilitate game execution tracking and restriction.

Architecture of an electronic game platform 100 of the invention may include a handheld facility 102 for receiving and executing a game program. The handheld facility 102 may include a CPU 104, memory 106, operating system 108, screen 110, video out 112, USB port 114, input control device 118 (e.g. button, keyboard, mouse, pointer), a wired interface for an input control device 120, wireless interface for an input control device 122, a battery 124, and a power port 128. The handheld facility 102 may further include a transaction facility 130.

The handheld facility 102 may receive electronic games through the USB port 114 or a network port 132 for purposes of executing the electronic games. The games may be embodied in the form of a computer program that is stored in the memory 106 and executed by the CPU 104 and O/S 108.

A user of the handheld facility 102 may interact with the facility 102 through the input control 118 and the screen 110. Alternative to, or in addition to the input control 118, the user may interface a wired remote input control 120 or a wireless 122 remote input control to the handheld facility 102. Alternative to, or in addition to the screen 110, the user may access the video out 112 for displaying remotely. These interface alternatives provide flexibility and facilitate use of the handheld facility 102 in a variety of environments.

A transaction facility 130 may be associated with the CPU 104 to facilitate tracking the execution of an electronic game by the handheld facility 102. The transaction facility 130 may facilitate recording each time an electronic game is executed by identifying an aspect of the game during execution. An example of an aspect may include a code which is known to the transaction facility 130 and presented to the transaction facility 130 during execution. The transaction facility 130 may directly record and retain a record of each execution of a game. The transaction facility 130 may directly record a count of the executions of a game. A count of executions may include the number of times the game is played, the duration of time a game is played, a count of game events (such as number of laps completed, levels completed, opponents defeated, items captured, property accumulated, goals achieved, items acquired, challenges overcome, lives lost, levels failed, times defeated, items lost, property lost, goals not achieved, and a wide range of other game events), processor time used, or the like. The count of executions associated with the game by the operating system may be compared to a permitted count, such as stopping play when a particular count level has been reached. The allowed count level may be varied, such as in response to game events, payments, or the like, such as allowing extended game play upon making a payment or completing a level of the game.

The handheld facility 102 may include a transactional facility for making payments, such as credit card payments or other electronic payments, including through the interface with the portable, external memory device.

The transaction facility 130 may provide a response to the CPU 104 upon receiving the code so that the CPU 104 may record either a record of each game execution or a count of game executions or other type of count (or some combination of the same). The memory 106 may maintain the record, perhaps in response to a signal from the CPU 104. The memory 106 may be non-volatile in that it may retain the record of execution even when power from the power port 128 and the battery 124 is not present.

The transaction facility 130 may further interact with the electronic game program so that uses of aspects of the game may also be tracked. This feature may facilitate tracking when one or more screens of the game are viewed, when more than one user simultaneously interfaces with the handheld facility 102, and the like, including any of the types of counts described herein.

The transaction facility 130 may further facilitate restricting use of a game on the handheld facility 102 based on an aspect of the game. The transaction facility 130 may provide a signal to the CPU 104 when a predetermined number of executions of the game have been recorded so that the CPU 104 may alert the user. Reaching the predetermined number of executions may result in the user having to take another action, such as and without limitation making a payment, providing information to continue executing the game, and so on.

The transaction facility 130 may facilitate controlled use of a game on the handheld facility 102 by comparing a code associated with the game with a code known to the transaction facility 130 and then signaling the CPU 104 if an aspect of the codes do not match. The code known to the transaction facility 130 may be configured through the handheld facility 102 by receiving the code and/or a program associated with the code through the USB 114 or network 132 ports. In an example, the code and/or program associated with the code may be presented to the handheld facility 102 by a server or other computing facility on the network 132 such as the Internet. In another example, a device connected to the USB port 114 may include the code and/or a program associated with the code. The handheld facility 102 may access the device on the USB port 114 to retrieve the code and/or program. Components of a transaction facility may reside in the operating system of the handheld facility 102, in the portable, external memory device, or in a remote computer, such as a server with ecommerce capability, or in a combination of the foregoing.

The code may be configured into the transaction facility 130 by the CPU 104. The transaction facility 130 may include a non-volatile memory for the code so that configuring the code only once is required. Alternatively, the code may be configured into the transaction facility by the CPU 104 at various times such as at power-on of the handheld facility 102. The code configured by the CPU 104 may be temporary such that the code is erased when power is removed.

The transaction facility 130 may be a physical aspect of the handheld facility 102 or it may be a software aspect such as a program or portion of the OS 108 executing on the handheld facility 102. The transaction facility may be a software service, such as a web service, deployed in a service oriented architecture, where some component of the transaction facility is accessed via a computer network, such as upon connection of the portable, external memory device to a computer that is connected to a network.

By using a code as herein described, the handheld facility 102 may facilitate use of game programs that enforce digital rights management. Alternatively, the transaction facility 130 may track execution of game programs without digital rights management. The code may facilitate tracking by uniquely identifying the game program being executed. The handheld facility 102 may support game programs such as open source programs.

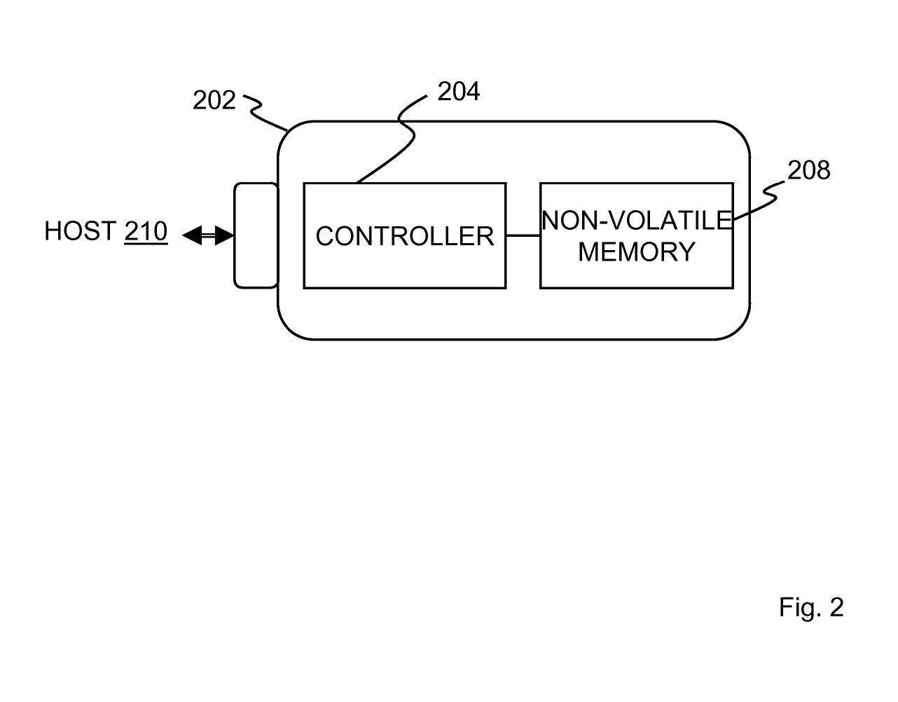

FIG. 2 depicts another aspect of the electronic game platform 100 in which an external, portable memory device 202 (such as and without limitation an USB device) may be adapted to track if/when a host computing facility such as the handheld facility 102 accesses a code that is stored in the memory device 202. The external memory device 202 may further include a controller 204 and a memory 208. The memory 208 may be a non-volatile memory as shown in FIG. 2. Alternatively, the memory may include volatile and non-volatile portions. The controller 204 may facilitate access to the memory 208 through the host port 210.

The controller 204 may support functions associated with accessing the memory 208 from the host port 210. In an example, the controller 204 may monitor access to the memory 208 such that accesses to a code stored in the memory 208 may be detected by the controller 204. The code may be associated with a game program. The game program may be executed by a host computing facility that may access the device 202 through the host port 210.

The controller 204 may facilitate tracking the execution of an electronic game by a host computing facility. The controller 204 may facilitate recording each time an electronic game is executed by identifying an aspect of the game during execution. An example of an aspect may include a code which is known to the controller 204 and presented to the controller 204 during execution. The code may be presented to the controller 204 by a host accessing the code in the memory 208 of the device 202. The controller 204 may directly record and retain a record of each execution of a game in the memory 208. The controller 204 may directly record a count of the executions of a game in the memory 208.

The controller 204 may provide a response to a host so that the host may record either a record of each game execution or a count of game executions or both.

The controller 204 may further interact with a host executing an electronic game program so that uses of aspects of the game may also be tracked. This feature may facilitate tracking when one or more screens of the game are viewed, when more than one user plays the game, and the like. The controller 204 may track the use of these and other features when the host accesses the memory device 202. The game program may be adapted to access the memory device 202 as needed to support tracking use of aspects of the game.

The controller 204 may further facilitate controlling use of a game on the host based on an aspect of the game. The controller 204 may provide a signal to the host when a predetermined number of executions of the game have been recorded so that the host may alert the user. Reaching the predetermined number of executions may result in the user having to take another action, such as making a payment or providing information to continue executing the game.

The controller 204 may facilitate restricting use of a game on the host by comparing a code associated with the game with a code known to the controller 204 and signaling the host if an aspect of the codes does not match. The code known to the controller 204 may be stored in the memory 208 of the memory device 202. The code associated with the game may be provided by the host over the host port 210.

The code known to the controller 204 may be configured by the host by writing the code to the memory device 202. The controller 204 may receive the code and/or a program associated with the code through the host port 210. In an example, the code and/or program associated with the code may be presented to the memory device 202 by a host adapted to configure the memory device 202. The host may be capable of executing a game program and configuring the memory device 202 through a USB port 114 as shown in FIG. 1.

The code may be stored from time to time in the memory device 202 by a host through the host port 210 to enable the memory device 202 to support other game programs. A plurality of codes may be stored in the memory device 202 such that a host accessing any of the codes may facilitate tracking and recording the execution of a game program on a host associated with the code.

The memory device 202 may include a code, a game program, or a game program and a code. The code may be part of the game program. The game program and/or the code may be stored in the non-volatile portion of the memory device 202. The host may access the game program, code, or both in the memory device 202 for purposes of executing the game program on the host. The controller 204 may record each access to the game program similarly to recording access to the code as herein described. A host may access the memory device 202 to store the game program, code, or both in the memory 208. The memory device 202 may be removed from the host and connected to another host so that execution of the game program on the other host may be tracked or controlled as herein described.

The memory device 202 may provide a report signal associated with the code or game program to the host through the host port 210. The report signal may encompass information relating to tracking associated with the game program and/or code stored on the memory device 202. The report signal may be related to a predetermined number of executions, or to an aspect of the game program as herein described. Alternatively, the signal may be related to a date, such as an expiration date associated with the execution of a game program tracked by the memory device 202. The report signal may appear as a file in a file system of the memory device 202.

Each access by a computer program executing on a host (such as an electronic game program) to the code that is stored in the memory device 202 may trigger tracking of the access. In an example the controller 204 may record the access as well as other information such as time and date. The computer program may provide additional information such as a user name, a number of users, a source of the program, and the like that may be recorded by the controller 204. The record may indicate that the program is running on a host computing facility.

The memory device 202 may automatically send information based at least in part on a configuration of the memory 208. The information may be associated with if/when a program that is stored in the memory device 202 is executed by a host computing facility. The host and/or the memory device 202 may generate the information. The host may be a handheld facility 102, a personal computer, a home entertainment system, or any and all other such devices.

It will be appreciated that the information, signals, and the like that may be provided by and/or stored in the memory device 202, the transaction facility 130, and so on may be communicated to the handheld facility 102, the host, or any other such computing facility. Such information, signals, and the like may encompass or be associated with a unique signifier or identifier of a game, host, handheld facility 102, and so on. Uses of such information, signals, and the like may be directed at preventing a game from be played in certain circumstances, on particular devices, and so on. Such information, signals, and the like may be directed at tracking interactions between a host, a handheld facility 102, a game, and the like. Information related to the tracking of such interactions may be reported back to a host, a server computer, a website, and the like. Information related to the tracking of such interactions may encompass an indication of how much the game has been used. The information, signals, and the like may be associated with a memory device 202. The information, signals, and the like may be associated with a transaction facility 130 of a handheld facility 102. The information, signals, and the like may be associated with both a memory device 202 and a transaction facility 130. Many other such embodiments will be appreciated and all such embodiments are within the scope of the present disclosure.

Electronic game tracking improvements may be associated with online activity, such as internet activity. Online activity may include interactive game play, multi-user game play, downloading games, uploading games, downloading game updates and access codes, download of information representing game aspects to be tracked, social networking, and the like.

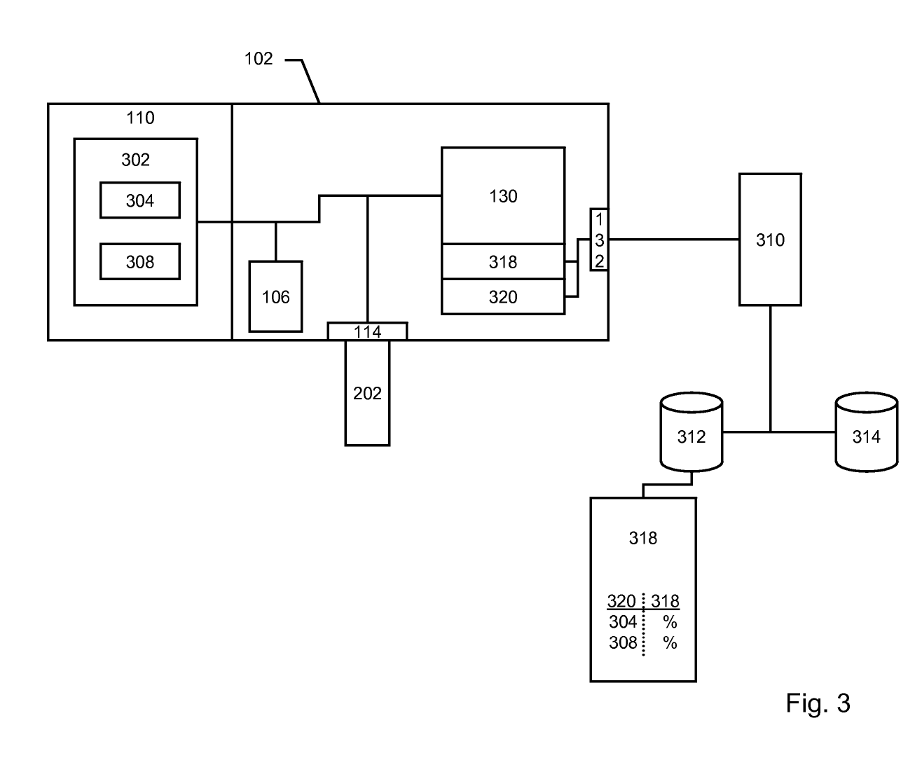

FIG. 3 depicts an online electronic game tracking embodiment of the methods and systems herein described. Handheld facility 102 may connect through network port 132 to a server 310 that may include data storage facilities to store electronic games 314 and tracking reports 312 that may have been retrieved from the handheld facility 102 by the server 310. The handheld facility 102 may include a transaction facility 130 that may track electronic games based on a tracking criterion 320 and/or a criteria tracking method 318. Transaction facility 130 may use the criteria 320 and the tracking method 318 to track aspects of a game 302, such as a first aspect 304 and a second aspect 308 that may be presented through the display 110. The handheld facility 102 may be in communication with an external memory facility 202 through the USB port 114.

In embodiments described herein, the server 310 may interact with the handheld facility 102 (or another embodiment of electronic game tracking such as software running on a computing facility) to facilitate determining what criteria 320 and what criteria tracking method 318 to employ for tracking a game 302. The server 310 may retrieve a tracking report 318 from the handheld facility 102 for storage in the report data facility 312. The report 318 may include tracking results for game aspects 304 and 308 that relate to the tracking criteria 320, and tracking data for the game aspects that relate to the tracking method 318. In the example embodiment of FIG. 3, game aspects 304 and 308 are defined by criteria 320 and the method of tracking 318 is to track a percent of user access to the tracked aspects. Handheld device may create report 318 and store it locally in memory 106 or external memory 202 so that it can be retrieved by server 310.

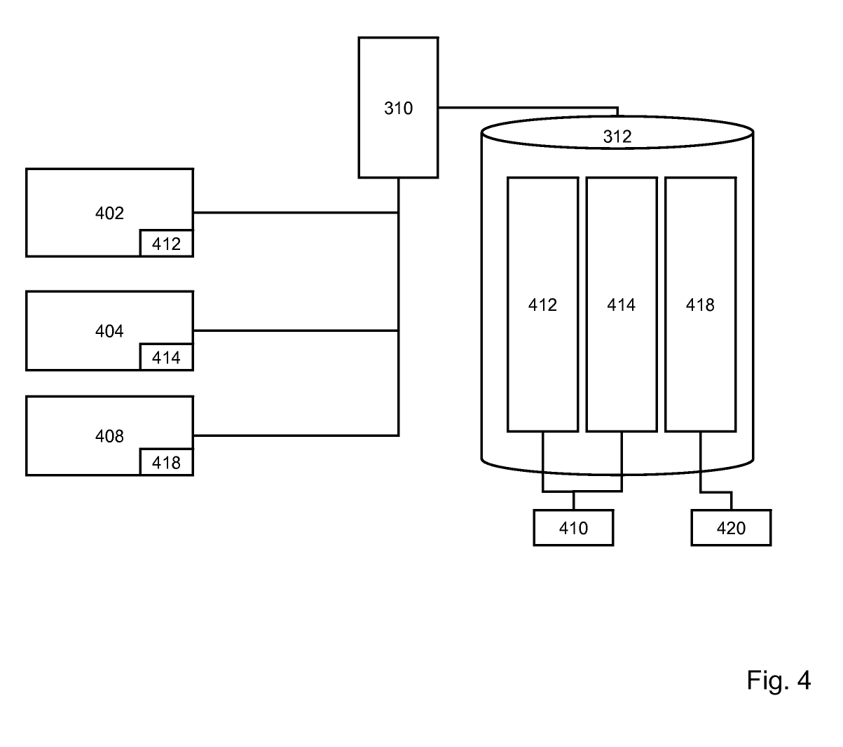

FIG. 4 depicts an embodiment of the methods and systems of electronic game tracking including a plurality of electronic game tracking facilities, associated tracking reports, and a relationship between the games and sponsors of the games. In FIG. 4, game tracking facilities 402, 404, and 408 may be connected, such as through the internet to a server 310 that may store tracking reports 412, 414, 418 for one or more of the game tracking facilities in a report data storage facility 312. Game sponsors 410 and 420 may be in communication with the server so that they can take advantage of the tracking reports related to games they sponsor. In FIG. 4, game sponsor 410 may sponsor games 402 and 404, while game sponsor 420 may sponsor game 408. These sponsorships may be made known to server 310 so that server 310 can facilitate the game sponsors having access to (or receiving) reports associated with the games for which they have responsibility. Each game tracking facility 402, 404, and 408 may generate a tracking report (412, 414, 418 respectively) that may be retrieved by server 310. Each game report may include game identification information (such as a game name, serial number, revision, and the like) that may be used by the server 310, by the sponsors 410, 420, or by both to associate a tracking report with a sponsor. Game sponsors 410 and 420 may include game developers, promoters, market researchers, investors, individuals (e.g. through a social networking posting), clubs, and the like.

Electronic game tracking improvements may be associated with interactive online game play. Tracking associated with online game play may include tracking requests for online game play, websites or URLs associated with online game play, a count and a record of online users participating in the online game play, features of the game accessed by online participants, time associated with game play sessions of online participants, and the like. A game that may be played through the handheld facility 102 or in association with the portable memory device 202 may be tracked so that online activity associated with the game is tracked. The information tracked may be useful for determining a popularity of the game or features of the game. Interactive online game play may be enabled by electronic game tracking by requiring online participants to provide information, such as demographics or identifying information to be associated with tracking of the online interactions.

Users may request download of games. The request may be honored based on a usage or tracking report that may be generated by electronic game tracking. In an example, an electronic game may be provided in a series of linked downloads that require the gamer to achieve a level of performance or success with a download before being authorized to access a linked download. Electronic game tracking may count and record various game executions, completed levels, and the like and provide a report to a website offering game downloads. Based on, for example, the highest completed level provided in the report, a user may be allowed to access the next linked download of the game.

A game sharing website, such as a site providing games for free may receive a user request to download a game. If the user request includes a game tracking/usage report generated with the electronic game tracking methods and systems herein described, the user may be offered a premium game or another option that may not be available to users that do not include game tracking reports in their download requests. In an example, a user may employ the methods and/or systems for electronic game tracking herein described on the user's home personal computer. The user may access a game website and request a game. During the course of interaction between the user and the website to process the request, the user may provide a game tracking report generated on the user's behalf. Alternatively, the website may download browser code, such as Java code, to the user's computer so that the downloaded code may automatically gather game tracking report information available on or through the user's computer. The downloaded browser code may interact with a game controller 102 or an external memory device 202 that is connected to and in communication with the web browser.

In a similar way, game uploading may be enabled through use of aspects of the game tracking methods and systems herein described. Users may request to upload a game, such as a game the user has created or modified, or a game that has been provided to the user. The electronic game tracker may track and record requests to upload (and/or download) games so that a report of tracked users' game upload (download) activity may be provided to an internet connected server associated with game uploading. The report may also indicate a number of times a user has tested a game to be uploaded, thereby establishing credibility associated with the game upload. Electronic game tracking may record each level within a game that a user has successfully passed or tested, providing additional details about the game to be uploaded. Other information, such as how many online users have used the game to be uploaded may also be provided to the upload website.

Electronic game tracking may be associated with online social networking. Social network participants may establish criteria associated with accessing aspects of their online social network information, such as electronic games, videos, and the like. The criteria may include requiring the game tracking methods and systems herein described to be deployed and executing on a user's computer to allow access. In an example, an online social network participant may post an electronic game in association with their online social network page that is available for download. A user may download a copy of the game if they agree to associate or have already associated the electronic game tracking technology herein described with their computing device to which the game is to be downloaded. In this way, the social network participant may track uses of the downloaded game. In another example of associating social networking with electronic game tracking, a user may establish a members-only online community for sharing games, other digital content, and the like. Membership may be based on presentation of an electronic game tracking report, and may be further based on information within the report.

Aspects of electronic games may be enabled based on an association of the aspect of the game and electronic tracking. Aspects of games that may be enabled include access to characters, scenes, challenges, features such as saving and restoring a game, and the like. Electronic game tracking may include enabling or allowing access to aspects of electronic games based on certain criteria determined in association with electronic game tracking software or hardware. In an example, a game tracking controller 102 may include an access code that enables access the aspects or features. The user may be required to provide the access code to access the aspects or features. The game, or other software associated with the game tracking controller 102 may offer to provide the access code to the user in exchange for compensation, such as a payment, providing information, and the like. The user may receive the access code, or may receive access to the protected aspects or features, upon providing the information or payment. Payment may be a micro payment, a virtual currency payment, a real world payment, and the like. Information provided may include demographics associated with the user, a URL, a friend's email address, the user's email address, a survey response, and the like.

Electronic game tracking may be associated with online identification of aspects of a game to track. While a wide variety of aspects of games may be tracked, identifying which specific aspects, of the many possible, should be tracked may be provided through an online interaction. A game sponsor or provider may incorporate or utilize electronic game tracking as herein described and may, from time to time, adjust the information tracked by providing information, such as in the form of a download, to game tracking software and/or hardware associated with a game that is related to the game web site. A game sponsor may provide aspects of a game that are related to an upcoming event, such as a presidential election. The game sponsor may provide an indication to electronic game tracking functionality to track user access to scenes or aspects of the game associated with the election until the election has occurred. After the election, the sponsor may provide an indication, such as through an online download, to the game tracking functionality to track different information. The game sponsor or other online party interested in game tracking may identify how an aspect is to be tracked. In an example, tracking presidential election scenes may be accumulated over a time frame such as a month when the election is a year away. The same tracking information may be accumulated over a shorter period of time, such as a week or a day as the election approaches.

The electronic game tracking technology, such as embodied as the external memory tracker 202 may essentially provide transaction facility capabilities (such as game tracking) while interacting with a computing facility to which it is logically and/or physically attached. The computing facility may be a personal computer, server, game controller, game console, set-top box, remote control, and the like. The external memory 202 may be used with the game controller 102 so that one or more aspects of a game may be tracked simultaneously. Alternatively, the game controller 102 may not directly include the game tracking technology and may, instead, rely on the external memory 202 to provide tracking capability.

Electronic game tracking may be associated with personal computers, web servers, and the like. In particular, electronic game tracking functionality may be associated with one or more operating systems such as MacOS, Linux, Windows, Vista, and the like. The game tracking technology may be adapted to provide a reliable, robust, easy to use interface that is associated with the operating system running on the computer or electronic device through which the electronic tracking is occurring.

Electronic game tracking, such as embodied in a handheld facility 102 or enabled by external memory facility 202, may be used for a variety of applications including market research, virtual e-commerce, digital rights management protection, other counting and tracking applications included herein, and the like. Game tracking information, such as may be included in a report described herein may be associated with similar reports from a variety of other electronic game tracking instances by, for example, a server that receives the reports over the internet. The associated reports may be analyzed to determine aspects of a population of electronic game players that may facilitate researching game player preferences, skill levels, and the like. In addition to the game tracking information, other information as may be collected by electronic game tracking, such as game identification information, IP address, and the like may be included in the report and included in market research.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
providing an external and removable memory device, wherein the memory device is adapted to track a host computing facility accessing a code that is stored in the memory device.

2. The method of claim 1, wherein the memory device is a USB memory device.

3. The method of claim 1, wherein the code is stored, from time to time, into a memory device by host computing facility.

4. The method of claim 1, wherein the code is part of a computer program that is stored, from time to time, into the memory device by a host computing facility.

5. The method of claim 4, wherein the computer program is a computer game.

6. The method of claim 1, wherein the memory device is further adapted to provide a report signal to a host computing facility, wherein the report signal encompasses information relating to the tracking.

7. The method of claim 6, wherein the report signal appears as a file in a file system of the memory device.

8. The method of claim 5, wherein the host facility stores the game program without the use of digital rights management.

9. The method of claim 5, wherein the game program is associated with an open-source software development kit.

10. A method comprising:
receiving information from a USB memory device, wherein the information is associated with an execution by a host computing facility of a program that is stored in the memory device.

11. The method of claim 10, wherein the information is generated by the memory device itself.

12. The method of claim 10, wherein the information includes at least two of a game execution, game time, and a game event.

13. The method of claim 10, wherein game time includes one or more of an accumulation of time the game is played, duration of a game execution, and a percent of idle time during a game execution.

14. The method of claim 10, wherein a game event is selected from the group consisting of downloading a game, uploading a game, starting a game, ending a game, pausing a game, defeating an opponent, capturing a game item, accumulating a game property, attempting a game level, completing a game level, achieving a goal, overcoming a challenge, loosing a game life, defeat, losing items, losing acquired property, reaching a game start count threshold, accessing a game feature, and adding a game participant to a game execution session.

15. A system comprising:
an external and removable memory device for tracking access to a code that is stored in the memory device.

16. The system of claim 15, wherein the memory device is a USB memory device.

17. The system of claim 15, further including a host for storing the code, from time to time, into the memory device.

18. The system of claim 17, wherein the code is part of a computer program, and wherein the host stores the computer program, from time to time, into the memory device.

19. The system of claim 18, wherein the computer program is a computer game.

20. The system of claim 19, wherein the game program is stored without the use of digital rights management.

21. The system of claim 19, wherein the game program is associated with an open-source software development kit.

22. The system of claim 15, wherein the memory device is further adapted to provide a report signal to a host computing facility, wherein the report signal encompasses information relating to the tracking.

23. The system of claim 22, further including a file system in the memory device for storing a file including the report signal.

24. The system of claim 22, wherein the information includes at least two of a game execution, game time, and a game event.

25. The system of claim 22, wherein game time includes one or more of an accumulation of time the game is played, duration of a game execution, and a percent of idle time during a game execution.
